(19) United States
(12) Patent Application Publication
(10) Pub. No.: US 2022/0288584 A1
(43) Pub. Date: Sep. 15, 2022

(54) A REACTIVE CARTRIDGE CARRYING SYSTEM

(71) Applicant: ANATOLIA TANI VE BIYOTEKNOLOJI ÜRÜNLERI ARASTIRMA GELISTIRME SANAYI VE TICARET ANONIM SIRKETI, Istanbul (TR)

(72) Inventor: Alper AKYÜZ, Istanbul (TR)

(21) Appl. No.: 17/417,558

(22) PCT Filed: Dec. 4, 2020
(86) PCT No.: PCT/TR2020/051229

§ 371 Date: Jun. 23, 2021

(30) Foreign Application Priority Data
Dec. 31, 2019 (TR) 2019/23083

(51) Int. Cl. B01L 3/00; B01L 9/00

(52) U.S. Cl. CPC B01L 3/50855; B01L 9/523; B01L 2200/023; B01L 2200/025; B01L 2200/028; B01L 2300/0829; B01L 2200/16

(57) ABSTRACT

A reactive cartridge carrying system convenient for use with laboratory devices providing application of various measurement and analysis operation for chemical or biological content fluid materials and having a carrying chamber of structure convenient for carrying pipes containing chemical or biological content fluid material or fluid material, of equal or different shape or volume, placed in sequence side by side, a carrying cartridge containing a raise-connected to edges of carrying chambers far to the floor and facing each other, extending in a manner parallel to floor and departing from each other, an intermediate carrying part providing carrying of carrying cartridge and containing a gap convenient for placement into carrying cartridge, an upper surface extending in a manner horizontal to the floor, foot connected to upper surface edge, a cartridge holder part providing carrying of carrying cartridge and intermediate carrying part and of structure convenient for placement into laboratory device.

### TECHNICAL FIELD

Invention relates to a reactive cartridge carrying system providing placement of more than one reactive cartridge into laboratory device and removal thereof from laboratory device regularly and in a fast manner.

Invention particularly relates to a reactive cartridge carrying system providing placement of cartridges convenient for placement of reactive therein into laboratory device performing operations such as measurement and analysis and removal it therefrom in a regular, fast and safe manner.

### PRESENT STATE OF THE ART

Various measurement and analyzing devices are used for application of various operations such as measurement, comparison and magnetizing of reactive materials in laboratories. Placement of reactive materials or mixtures into or removal from said measurement and analysis devices is performed by means of carrying apparatus called reactive cartridge. Reactive cartridges have more than one housing in same or different sizes, and placement of said reactive into said housing is provided. Cartridges containing reactive are placed into cartridge holders or special carrying sections of inside the device and are subjected to said operations. However, multiple number of reactive cartridges are required to be placed into measurement and analysis device during process of more than one reactive sample. User has to put and remove his/her hands in and from the device several times during placement of cartridges as each cartridge is filled separately. This causes waste of long time for cartridge loading and therefore loss in purity of reactive material as well as infection of user, which means double side contamination risks. In addition, during repeated application of cartridge placement into and cartridge removal from the device, user's risk to make mistake increases and may cause negative results such as misplacement of cartridges and having faulty results.

In the related art patent document numbered U.S. Pat. No. 9,274,132B2 relates to a system and method providing analysis of samples. Said system provides application of operations in different positions to cartridges used for analysis of materials such as biological fluids. System that can be used in polymerizes chain reaction operations comprises reactive cartridges containing several operation stations such as optic and thermal analysis, special carrying chambers providing placement of cartridge into said stations and chambers of various sizes for carrying different reactive. Said cartridges are of structures comprising sequenced chambers in one line and can be placed into said carrying parts side by side. However, it is not possible to conduct placement of reactive cartridges into system repetitively and remove them in a fast way by use of said system. In addition, the document does not offer a solution for elimination of double side contamination risks of loss of purity of reactive material and infection catching by the user during cartridge loading operation.

As a result, it is needed to disclose a reactive cartridge carrying system providing placement of cartridges convenient for reactive placement therein, into laboratory device performing measurement and analysis like operations and removal it therefrom in a fast, free of faults safe way and preventing double side contamination.

### Purpose of the Invention

The present invention relates to a reactive cartridge carrying system meeting the needs mentioned above, eliminating potential disadvantages and providing some additional advantages.

Primary purpose of reactive cartridge carrying system of the invention is to provide a reactive cartridge carrying system providing easy placement of reactive cartridge into laboratory device and removal thereof from.

Another purpose of the invention is to provide a reactive cartridge carrying system providing placement and removal of more than one reactive cartridge into and from laboratory device at once and in fast way.

A further purpose of the invention is to provide a reactive cartridge carrying system providing placement and removal of more than one reactive cartridge into and from laboratory device in a safe and free of fault way preventing double side contamination during repetitive placement thereof.

In order to achieve above mentioned purposes in the most general way, the invention is a reactive cartridge carrying system convenient for use with laboratory devices providing application of various measurement and analysis operation for chemical or biological content fluid materials and comprises at least two carrying chambers of structure convenient for carrying pipes containing chemical or biological content fluid material or fluid material, of equal or different shape or volume, placed in sequence side by side in a line, at least a carrying cartridge containing at least two extensions connected to edges of carrying chambers far to floor and facing each other, extending in a manner parallel to floor and departing from each other, at least an intermediate carrying part providing carrying of carrying cartridge and containing a gap convenient for placement into carrying cartridge, at least an upper surface extending in a manner horizontal to floor, at least two feet connected to upper surface edge, at least a cartridge holder part providing carrying of carrying cartridge and intermediate carrying part.

The structural and characteristics features of the invention and all advantages will be understood better in detailed descriptions with the figures given below and with reference to the figures, and therefore, the assessment should be made taking into account the said figures and detailed explanations.

### BRIEF DESCRIPTION OF THE DRAWINGS

In order to make the embodiment being subject of the present invention as well as the advantages clearer for better understanding, it should be assessed with reference to the fallowing described figures.

FIG. 1 is a perspective view of reactive cartridge carrying system of the invention.

FIG. 2 is a perspective view of carrying cartridge and intermediate carrying part of reactive cartridge carrying system of the invention.

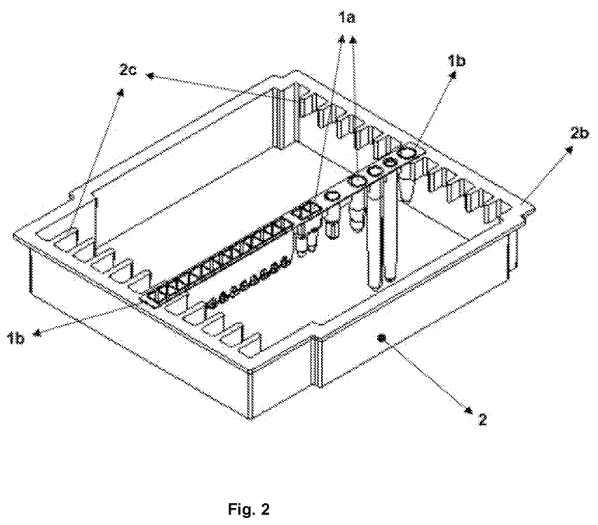

### PART REFERENCES

1. Carrying cartridge

1a. Carrying chamber

1b. Raise

2. Intermediate carrying part

2a. Gap

2b. Second raise

2c. Extension

3. Cartridge holder part

3a. Second gap

3b. Foot

3c. Housing

### DETAILED DESCRIPTION OF THE INVENTION

In this detailed description, the preferred embodiments of the reactive cartridge carrying system being subject of the invention have been described in a manner not forming any restrictive effect and only for purpose of better understanding of the matter.

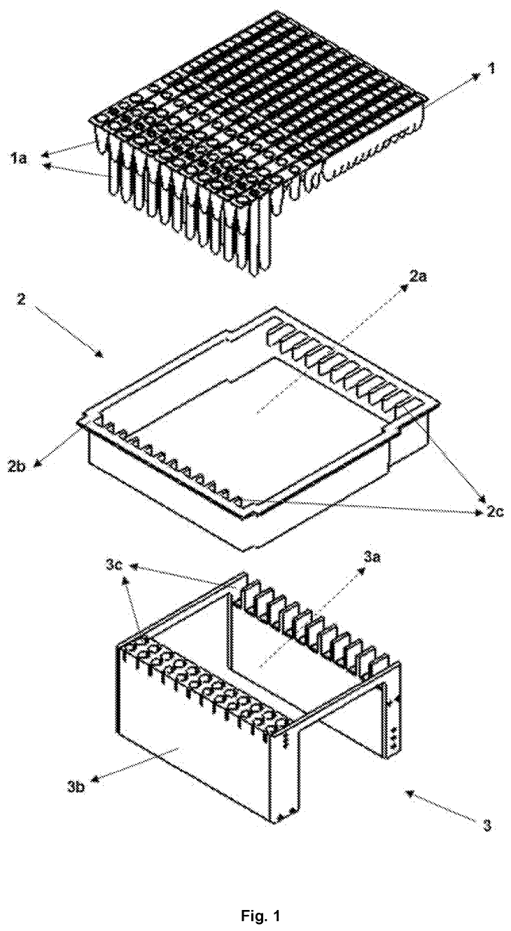

Reactive cartridge carrying system illustrative view shown in FIG. 1, developed under the invention, convenient for use with laboratory devices providing application of various measurement analysis operations such as measurement, comparison and magnetizing to chemical or biological content fluid materials comprises at least two carrying chambers (1a) of structure convenient for carrying pipes containing chemical or biological content fluid material or fluid material, having equal or different shape or volume, preferably extending towards floor and having edge far from floor in open cylinder form, placed in sequence side by side in a line, at least a carrying cartridge (1) containing at least two raises (1b) connected to edges of carrying chambers far to floor and facing each other, extending in a manner parallel to floor and departing from each other, at least an intermediate carrying part (2) in rectangular frame form providing carrying of carrying cartridge (1) and containing a gap (2a) convenient for placement into carrying cartridge (1). In addition, it also comprises at least an upper surface comprising a second gap (3a) for placement of carrying cartridge (1) preferably in central area, extending horizontal to floor and preferably placing onto intermediate carrying part (2) easily by sliding, having a surface area from surface area extending horizontal to floor, at least a cartridge holder part (3) comprising at least two feet (3b) providing fixed placement of carrying cartridge (1) into laboratory device and having connection with upper surface edge, providing carrying of carrying cartridge (1) and intermediate carrying part (2) and convenient structure for location into laboratory device.

In an illustrative application of reactive cartridge carrying system developed under the current invention tubes containing reactive to be used in DNA purification are placed into carrying chambers (1a) in carrying cartridge (1). Then its placement into gap (2a) provided in intermediate carrying part (2) of at least a full carrying cartridge (1) is provided and sliding and falling of carrying cartridge (1) into gap (2a) is prevented by help of extension (1b). Sliding and placement of intermediate carrying part (2) wherein carrying cartridge (1) is placed, onto cartridge holding part (3) and placement therein is provided. Sliding of intermediate part (2) over cartridge holding part (3) is provided for system removal of said carrying cartridges (1) is and/or loading of new carrying cartridges (2) and thus it is provided to place all carrying cartridges (1) into laboratory device with one single motion in operations using particularly multiple number of carrying cartridge (1) or removal therefore from inside the laboratory device.

In a preferred application of the invention, said reactive cartridge carrying system comprises at least one intermediate carrying part (2) comprising at least two second raises (2b) connected to two edges facing each other and far from floor to enhance physical strength of said intermediate carrying part (2), parallel to floor in a manner to leave away from said gap (2a).

In another preferred application of the invention, said reactive cartridge carrying system comprises at least one intermediate carrying part (2) comprising at least two extensions (2c) located in a manner to remain between both carrying cartridges (1) located side by side and extending in same line towards each other from both facing edges and parallel to floor for placement of more than one carrying cartridge (1) parallel to each other. Thus sliding of each carrying cartridge (1) on axis extending parallel to floor is prevented.

In another preferred application of the invention, said reactive cartridge carrying system comprises at least one housing (3c) comprising at least two feet (3b) extending parallel to each other along edges of said upper surface facing each other and located on surfaces of said feet (3b) far from floor, having form convenient for placement into said carrying chambers (1a).

In another preferred application of the invention, said reactive cartridge carrying system said reactive cartridge carrying system comprises at least two housings (3c) located on surface of said feet (3b) far from floor, in the structure convenient for placement of said carrying cartridge (1) in a manner extending between said feet (3b), located parallel to each other and edge far from floor in open “U” form and/or convenient for placement of said carrying chamber (1a) thereinto, located parallel to each other, edge extending towards floor and near to said carrying cartridge (1) in open cylinder form.

In a preferred alternative application of the invention, said reactive cartridge carrying system comprises at least a carrying cartridge (1) comprising housing containing reactive convenient for nucleic acid isolation, magnetic operation housing, sample adding housing, filtered end placement housing, purified nucleic acid elusion collection housing and/or at least a carrying chamber (1a) of sonicator housing feature.

Reactive cartridge carrying system developed under the invention provides placement of one or more than one carrying cartridge (1) convenient for placement of reactive therein into a laboratory device at once and removal of it from device. In addition, sliding of carrying cartridges (1) on axis horizontal to floor is prevented, one way motion inside intermediate carrying part (2) is allowed and thus a reactive cartridge carrying system providing an easy, fast, free of faults and double side contamination preventive way of placement and removal is obtained.

1. A reactive cartridge carrying system convenient for use with laboratory devices providing application of various measurement and analysis operation for chemical or biological content fluid materials, the reactive cartridge carrying system comprising:
at least one carrying cartridge comprising at least two carrying chambers of structure convenient for carrying pipes containing chemical or biological content fluid material or fluid material, having equal or different shape or volume, placed in sequence side by side in a line, at least two raises connected to edges of carrying chambers far to floor and facing each other, extending in a manner parallel to floor and departing from each other;
at least one intermediate carrying part providing carrying of said carrying cartridge in rectangular frame form containing a (2a) convenient for placement into carrying cartridge in central area;
at least one cartridge holder part comprising at least an upper surface extending horizontal to floor, at least two feet connected to edge of said upper surface and providing fixed placement of said carrying cartridge into said laboratory device, providing carrying of said carrying cartridge and said intermediate carrying part and of convenient structure for placement into said laboratory device.

2. The reactive cartridge carrying system according to claim 1, wherein the system is in a circular or square cross-sectioned cylinder form with open edge of said carrying chamber extending towards floor and far from floor.

3. The reactive cartridge carrying system according to claim 1, wherein the upper surface of said cartridge holder part has a surface area smaller than a surface area of said intermediate carrying part extending horizontal to floor so that said intermediate carrying part slides and locates thereonto easily.

4. (canceled) The reactive cartridge carrying system according to claim 1, comprising at least one second gap located in central area and convenient for placement of said cartridge holder part into said carrying cartridge.

5. The reactive cartridge carrying system according to claim 1, comprising at least two second raises connected to two edges facing each other and far from floor and extending parallel to floor in a manner departing from said gap in order to enhance physical strength of said intermediate carrying part.

6. The reactive cartridge carrying system according to claim 1, wherein said intermediate carrying part comprises at least two extensions located in a manner to remain between both carrying cartridges located side by side and extending in same line towards each other from both facing edges and parallel to floor for placement of more than one carrying cartridge parallel to each other.

7. The reactive cartridge carrying system according to claim 1, wherein said cartridge holder part comprises at least one housing comprising at least two feet extending parallel to each other along edges of said upper surface facing each other and located on surfaces of said feet far from the floor, having form convenient for placement into said carrying chambers.

8. The reactive cartridge carrying system according to claim 6, wherein said housings are in the structure convenient for placement of said carrying cartridge in a manner extending between said feet, located parallel to each other and edge far from floor in open “U” form and/or convenient for placement of said carrying chamber thereinto, located parallel to each other, edge extending towards floor and near to said carrying cartridge in open cylinder form.

9. The reactive cartridge carrying system according to claim 1, wherein said carrying cartridge comprises at least two carrying chambers comprising a housing containing reactive convenient for nucleic acid isolation, magnetic operation housing, sample adding housing, filtered end placement housing, purified nucleic acid elusion collection housing and/or at least two carrying chambers of sonicator housing feature.
